(19) United States
(12) Patent Application Publication
(10) Pub. No.: US 2006/0062134 A1
(43) Pub. Date: Mar. 23, 2006

(54) Optical storage medium and recording/reproduction apparatus and method

(75) Inventors: Kenichi Shimomai, Mito-Shi (JP); Ikuo Matsumoto, Mito-Shi (JP)

Correspondence Address: RENNER, KENNER, GREIVE, BOBAK, TAYLOR & WEBER;Fourth Floor, First National Tower, Akron, OH, 44308-1456, US

(73) Assignee: Victor Company of Japan, Ltd.

(21) Appl. No.: 11/214,439

(22) Filed: Aug. 29, 2005

(30) Foreign Application Priority Data
Sep. 2, 2004 (JP) 2004-255872
Jul. 1, 2005 (JP) 2005-193525

(51) Int. Cl. G11B 7/24

(52) U.S. Cl. 369/275.1; 369/283; 369/272.1

(57) ABSTRACT

An optical storage medium has a first layer structure and a second layer structure. The first layer structure includes a first substrate having a light-incident surface via which light is incident for recording or reproduction and a first surface having first concave sections and first convex sections, formed in order on the first surface being at least a first recording layer and a semi-transparent film, the first convex sections sticking out toward the light-incident surface, first recording tracks being provided on first portions of the first recording layer, the first portions corresponding to the first convex sections that are wobbling at a fixed frequency between an inner edge and an outer edge of the optical storage medium. The second layer structure includes a second substrate having a second surface having second concave sections and second convex sections, formed in order on the second surface being at least a reflective film and a second recording layer, the second concave sections caving in when viewed from the light-incident surface, the second layer structure being bonded to the first layer structure so that the first surface of the first substrate and the second surface of the second substrate face each other, second recording tracks being provided on second portions of the second recording layer, the second portions corresponding to the second concave sections that are wobbling at a fixed frequency between the inner and outer edges, at least one second convex section being provided with a pre-pit carrying address data for one of second recording tracks closer to the outer edge than the pre-pit is, the second convex section provided with the pre-pit being located closer to the inner edge than the second concave sections are, the location being corresponding to one of several second concave sections that are wobbling most towards the inner edge.

### CROSS-REFERENCE TO RELATED APPLICATIONS

This application is based on and claims the benefit of priority from the prior Japanese Patent Application No. 2004-255872 filed on Sep. 2, 2004, and the prior Japanese Patent Application No. 2005-193525 filed on Jul. 1, 2005, the entire contents of which are incorporated herein by reference.

### BACKGROUND OF THE INVENTION

The present invention relates to an optical storage medium having spiral or concentric data-recording tracks formed on a substrate that are wobbling at a fixed frequency and pre-pits carrying address data between the tracks, and also an apparatus and a method for recording/reproducing data on/from the optical storage medium.

Particularly, this invention relates to an optical storage medium having a plurality of layers each having such data-recording tracks, and a recording/reproduction apparatus for recording/reproducing data on/from the optical storage medium.

Optical storage media are classified roughly into read-only, write-once and rewritable media.

Generally, write-once and rewritable optical storage media have a recording layer made of an organic dye or a phase-change material and formed on a substrate. Data, such as video data, are recorded in grooves on a recording layer that are wobbling at a fixed frequency in a radial direction of an optical storage medium, such as, a write-once (DVD-R) or rewritable (DVD-RW) optical storage medium. While data is being recorded by a recording/reproduction apparatus, an optical storage medium is rotated at a constant linear velocity, independently of a recording position on the optical storage medium in the radial direction, by a spindle motor controlled by a servo synchronous signal generated based on a wobble signal generated in accordance with the wobbling grooves.

Developed recently to meet demands for larger storage capacity are dual-layer optical storage media having two recording layers, data being allowed to be recorded/reproduced on/from the two layers with laser beams in the same direction to the two layers.

Several techniques have been proposed for producing write-once and rewritable optical storage media. For example, Japanese Unexmined Patent Publication No. 2003-281791 discloses a layer stacking technique.

FIG. 1 is a cross-sectional view of a dual-layer optical storage medium (disk) D1 produced by the layer stacking technique. The disk D1 has a layer structure L0 and also a layer structure L1 stacked thereon, each like a single-layer optical storage medium, such as DVD-R, having a single recording layer. The layer structure L0 is located closer to a light-incident plane via which a laser beam is incident than the layer structure L1 is.

The layer structure L0 consists of a recording layer 72 and a semi-transparent layer 73 formed in order on a substrate 71 having a light-incident plane 71A via which a laser beam is incident in recording or reproduction.

The layer structure L1 consists of a recording layer 75 and a reflective layer 76 formed in order on a substrate 74.

In recording or reproduction, laser beams La and Lb are incident on the layer structures L0 and L1, respectively, via the light-incident plane 71A. The laser beams La and Lb are then focused on grooves 71G and 74G of the layer structures L0 and L1, respectively.

In FIG. 1, data are recorded in the layer structures L0 and L1 by on-groove recording, like a single-layer optical storage medium. The layer structures L0 and L1 are provided with land pre-pits according to the same requirements. On-groove recording will be explained later.

The layer stacking technique is disadvantageous in that it has complicated processes and difficulty in achieving high productivity due to successive stacking of several layers on the substrate 71 beginning from the recording layer 72, as shown in FIG. 1. Especially, the substrate 74 of the layer structure L1 has to be formed by molding photopolymer (2P resin) with a flexible stamper. This causes problems in peeling process after the substrate 74 is formed, a short life for the flexible stamper, etc.

In order to solve such problems in the layer stacking technique, Japanese Unexmined Patent Publication No. 2003-303447 discloses a layer bonding technique with simpler production processes.

In the layer bonding technique, substrates of layer structures L0 and L1 formed by injection molding in the same technique as for single-layer optical storage media are provided with recording and reflective layers and then bonded to each other, thus a dual-layer optical storage medium being produced.

The layer bonding technique employs several processes the same as those for single-layer optical storage media, without complicated processes. Thus, this technique provides optical storage media at low cost with simple processes.

Nonetheless, it is found that the layer bonding technique has problems of cross-write, etc., due to existence of the reflective layers in recording of data to the layer structure L1 by on-groove recording.

Discussed next are on-groove recording and in-groove recording.

Write-once and writable optical storage media are provided with spiral or concentric concave and convex sections alternately formed on a substrate. Either the concave sections or the convex sections are used as recording areas, except for a certain type (DVD-RAM).

Here, either the concave or the convex sections used as recording areas are called “grooves”. In other words, the sections formed on a substrate are called “grooves” when they are used as recording areas, without respect to whether they are concave or convex sections to the light-incident plane of the substrate via which a laser beam is incident. The other concave sections formed alternately with these convex sections as “grooves” or the other convex sections formed alternately with these concave sections as “grooves” are called “lands”.

In on-groove recording, data is recorded on a recording material applied on convex sections of a substrate that stick out toward a light-incident plane of the substrate. One-side recording type optical storage media (with storage capacity of 4.7 GB), such as DVD-R and DVD-RW, employ on-groove recording.

On the contrary, in in-groove recording, data is recorded on a recording material applied on concave sections of a substrate, that cave in when viewed from a light-incident plane of the substrate.

In the layer bonding technique, a layer structure L0 is produced in such a way that a recording layer is applied over a substrate surface having concave and convex sections followed by a reflective layer formed almost flat on the recording layer. In contrast, a layer structure L1 is produced in such a way that a reflective layer is formed on a substrate before a recording layer. Thus, the formed reflective layer has concave and convex sections that correspond to those sections formed on the substrate, different from the counterpart in the layer stacking technique shown in FIG. 1. The layer structures L0 and L1 are then bonded to each other so that the recording layers face each other as the substrates are provided outermost.

A reflective layer of a layer structure L1 has concave and convex sections in the layer bonding technique, as discussed above. This causes thermal diffusion in a lateral direction of a recording layer of the layer structure L1 when a laser beam hits “grooves” (convex sections sticking out toward a light-incident plane) as a recording area in on-groove recording. This is because heat generated by the laser beam is spread to “lands” (concave sections that cave in when viewed from the light-incident plane) via the reflective layer that exhibits a high thermal conductivity, resulting in recording not only on the “grooves” but also the “lands” of the recording layer.

It is found that data recorded on a “land” next to a “groove” is erroneously read instead of data recorded on this “groove”.

Such a problem might be solved by in-groove recording using concave sections (that cave in when viewed from a light-incident plane) as “grooves”. In-groove recording allows a reflective layer to sufficiently cool “grooves” (concave sections) on a recording layer, thus preventing spread of heat generated by a laser beam in a lateral direction of the recording layer.

Nevertheless, in-groove recording causes malfunction for an recording/reproducing apparatus, such as, off-tracking and erroneous detection of pre-pit signals from land pre-pits, when employed for optical storage media, such as DVD-R and DVD-RW for which on-groove recording is the standard recording technique.

### SUMMARY OF THE INVENTION

A purpose of the present invention is to provide an optical storage medium having a plurality of recording layers and produced by the layer stacking technique that achieves high recordability and reproducibility on and from each recording layer.

Another purpose of the present invention is to provide an optical storage medium, a recording/reproduction apparatus and a recording/reproduction method that achieve high recordability and reproducibility with accurate detection of pre-pit signals under in-groove recording.

The present invention provides an optical storage medium comprising: a first layer structure including a first substrate having a light-incident surface via which light is incident for recording or reproduction and a first surface having first concave sections and first convex sections, formed in order on the first surface being at least a first recording layer and a semi-transparent film, the first convex sections sticking out toward the light-incident surface, first recording tracks being provided on first portions of the first recording layer, the first portions corresponding to the first convex sections that are wobbling at a fixed frequency between an inner edge and an outer edge of the optical storage medium; and a second layer structure including a second substrate having a second surface having second concave sections and second convex sections, formed in order on the second surface being at least a reflective film and a second recording layer, the second concave sections caving in when viewed from the light-incident surface, the second layer structure being bonded to the first layer structure so that the first surface of the first substrate and the second surface of the second substrate face each other, second recording tracks being provided on second portions of the second recording layer, the second portions corresponding to the second concave sections that are wobbling at a fixed frequency between the inner and outer edges, at least one second convex section being provided with a pre-pit carrying address data for one of second recording tracks closer to the outer edge than the pre-pit is, the second convex section provided with the pre-pit being located closer to the inner edge than the second concave sections are, the location being corresponding to one of several second concave sections that are wobbling most towards the inner edge.

Moreover, the present invention provides an optical storage medium comprising: a first layer structure including a first substrate having a light-incident surface via which light is incident for recording or reproduction and a first surface having first concave sections and first convex sections, formed in order on the first surface being at least a first recording layer and a semi-transparent film, the first convex sections sticking out toward the light-incident surface, first recording tracks being provided on first portions of the first recording layer, the first portions corresponding to the first convex sections that are wobbling at a fixed frequency between an inner edge and an outer edge of the optical storage medium; and a second layer structure including a second substrate having a second surface having second concave sections and second convex sections, formed in order on the second surface being at least a reflective film and a second recording layer, the second concave sections caving in when viewed from the light-incident surface, the second layer structure being bonded to the first layer structure so that the first surface of the first substrate and the second surface of the second substrate face each other, second recording tracks being provided on second portions of the second recording layer, the second portions corresponding to the second concave sections that are wobbling at a fixed frequency between the inner and outer edges, at least one second convex section being provided with a pre-pit, the second convex section provided with the pre-pit being located closer to the outer edge than the second concave sections are, the location being corresponding to one of several second concave sections that are wobbling most towards the outer edge, wherein the optical storage medium has pre-recorded control data for recording to the second recording tracks, the control data further indicating a threshold level, to be used for detecting a pre-pit signal that is generated when the pre-pit is reproduced, to be set at a first side or a second side opposite to the first side in amplitude of a wobble signal that corresponds to the wobbling second concave sections.

Furthermore, the present invention provides an apparatus for performing at least either recording or reproduction comprising: an optical head for emitting a light beam for recording or reproduction to and receiving a return beam from an optical storage medium having recording tracks that wobble at a fixed frequency, provided between the recording tracks being pre-pits that carry address data for the recording tracks, and having pre-stored control data indicating a threshold level to be used for detecting pre-pit signals that are generated when the pre-pits are reproduced; a processor to gain and process the control data from the return beam; a generator to generate a pre-pit-superposed wobble signal based on the return signal, the pre-pit-superposed wobble signal having a wobble signal that corresponds to the wobbling recording tracks and pre-pit signals that correspond to the pre-pits, the pre-pit signals being superposed on the wobble signal; a detector to detect the pre-pit signals from the pre-pit-superposed wobble signal by using the threshold level gained from the processed control data; a demodulator to demodulate the detected pre-pit signals to gain the address data; and a controller to control the detector based on the processed control data so that the gained threshold level is set at a first side or a second side opposite to the first side in amplitude of the pre-pit-superposed wobble signal.

Moreover, the present invention provides a method of performing at least either recording or reproduction comprising the steps of: emitting a light beam for recording or reproduction to and receiving a return beam from an optical storage medium having recording tracks that wobble at a fixed frequency, provided between the recording tracks being pre-pits that carry address data for the recording tracks, and having pre-stored control data indicating a threshold level to be used for detecting pre-pit signals that are generated when the pre-pits are reproduced; processing the control data gained from the return beam; generating a pre-pit-superposed wobble signal based on the return signal, the pre-pit-superposed wobble signal having a wobble signal that corresponds to the wobbling recording tracks and pre-pit signals that correspond to the pre-pits, the pre-pit signals being superposed on the wobble signal; detecting the pre-pit signals from the pre-pit-superposed wobble signal by using the threshold level gained from the processed control data; demodulating the detected pre-pit signals to gain the address data; and controlling the detector based on the processed control data so that the gained threshold level is set at a first side or a second side opposite to the first side in amplitude of the pre-pit-superposed wobble signal.

### BRIEF DESCRIPTION OF DRAWINGS

FIG. 1 shows a cross-sectional view of a known dual-layer optical storage medium produced by a layer stacking technique;

FIG. 2 shows an enlarged sectional view of an embodiment of an optical storage medium according to the present invention;

FIG. 3 shows a plan view illustrating the optical storage medium shown in FIG. 2;

FIG. 4 shows an enlarged perspective view illustrating a fragment of a substrate of the first layer structure of the optical storage medium shown in FIG. 2;

FIG. 5 shows an enlarged schematic illustration of “lands” and “grooves” in the first layer structure of the optical storage medium shown in FIG. 2 when viewed from the upper surface for labeling in FIG. 2;

FIG. 6A illustrates arrangements of “grooves”, “lands” and land pre-pits;

FIG. 6B illustrates a radial push-pull signal gained from the arrangements shown in FIG. 6A;

FIG. 7 illustrates a quadrant photo-detector;

FIG. 8A illustrates “grooves” and a land pre-pit formed between adjacent two “grooves” in the first layer structure in on-groove recording;

FIG. 8B illustrates a radial push-pull signal S gained from the arrangements shown in FIG. 8A;

FIG. 9A illustrates “grooves” and land pre-pits each formed between adjacent two “grooves” in the second layer structure in in-groove recording;

FIG. 9B illustrates a radial push-pull signal S gained from the arrangements shown in FIG. 9A;

FIG. 10 shows an enlarged schematic illustration of “lands” and “grooves” in the second layer structure of the optical storage medium shown in FIG. 2 when viewed from the upper surface for labeling in FIG. 2;

FIG. 11 shows a block diagram of an embodiment of a recording/reproduction apparatus for recording/reproduction to/from the optical storage medium shown in FIG. 2, according to the present invention;

FIG. 12A shows a flowchart for a recording/reproduction operation of the recording/reproduction apparatus shown in FIG. 11 for the first modification to the embodiment of the optical storage medium shown in FIG. 2;

FIG. 12B shows a flowchart for a recording/reproduction operation of the recording/reproduction apparatus shown in FIG. 11 for the second modification to the embodiment of the optical storage medium D2 shown in FIG. 2;

FIG. 13A illustrates a modification to the land pre-pit shown in FIG. 4; and

FIG. 13B illustrates another modification to the land pre-pit shown in FIG. 4.

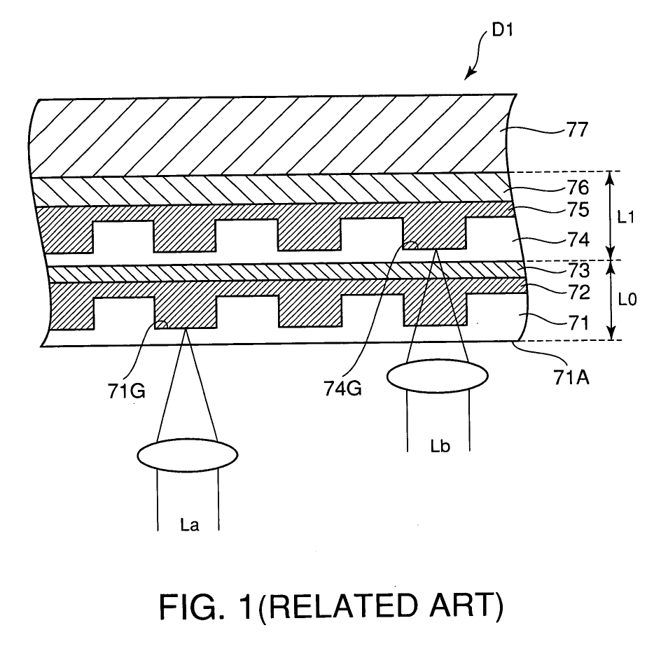

### DETAILED DESCRIPTION OF PREFERRED EMBODIMENT

An embodiment of the optical storage medium according to the present invention produced by the layer stacking technique will be disclosed.

The following embodiment is a write-once optical storage medium (DVD-R). However, the present invention is also applicable to other types, such as, a rewritable optical storage medium (DVD-RW) using a phase-change material.

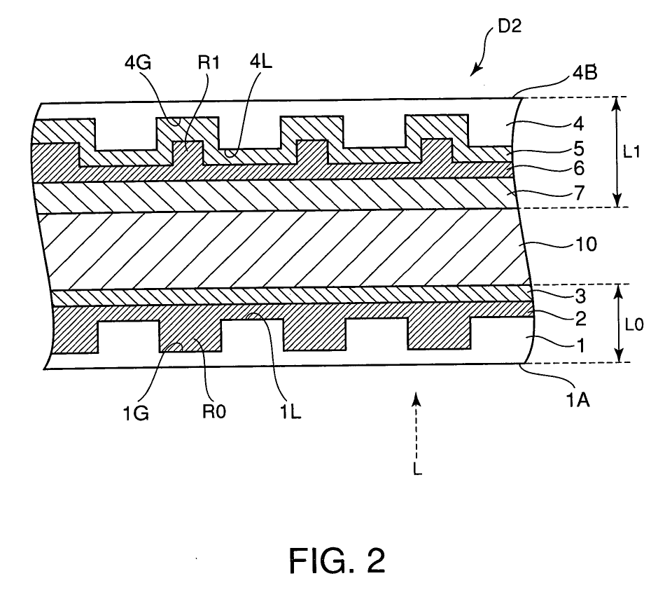

FIG. 2 shows an enlarged sectional view of an embodiment of an optical storage medium D2 according to the present invention.

A substrate 1 has “grooves” 1G that wobble on a surface of the substrate at a fixed frequency. An organic-dye recording layer 2 and a semi-transparent reflective film 3 are formed in order on the substrate 1, thus constituting a first layer structure L0. The sections of the organic-dye recording layer 2 that correspond to the “grooves” 1G are data-recording tracks.

The substrate 1 is made of a substance that exhibits high transparency to a laser beam in recording or reproduction. A suitable material for the substrate 1 is a resin for easier substrate formation by injection molding for higher productivity, especially polycarbonate, acrylic resin, etc.

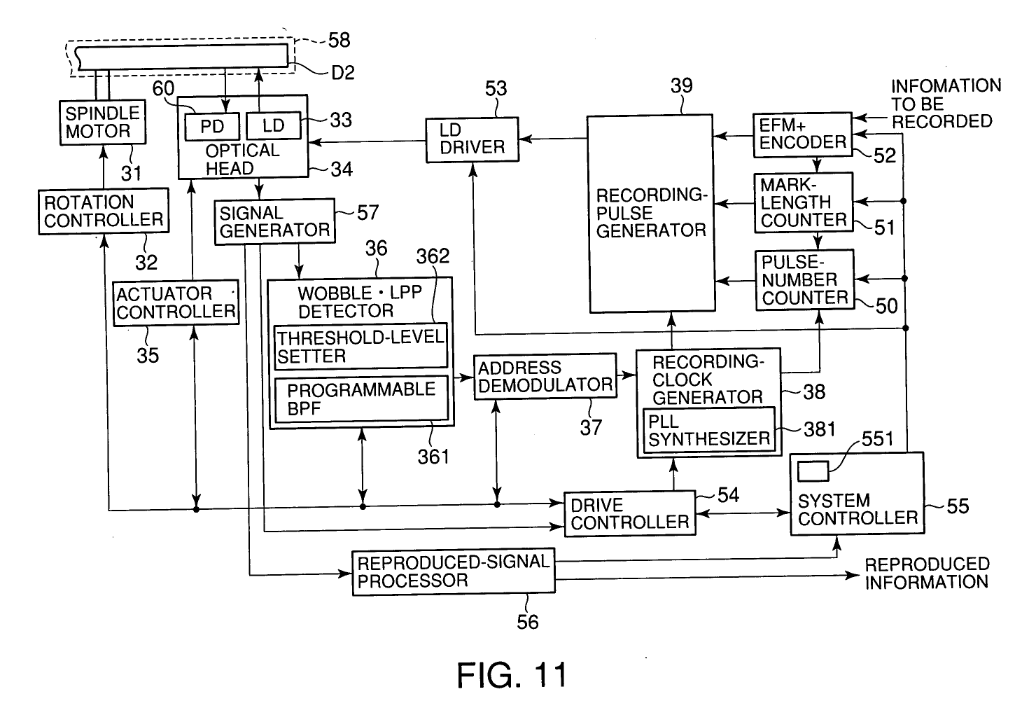

The other surface of the substrate 1 is a flat light-incident plane 1A. Incident on the light-incident plane 1A in a direction L indicated by an arrow, in recording or reproduction, is a laser beam emitted by an optical head (pick-up) 34 shown in FIG. 11.

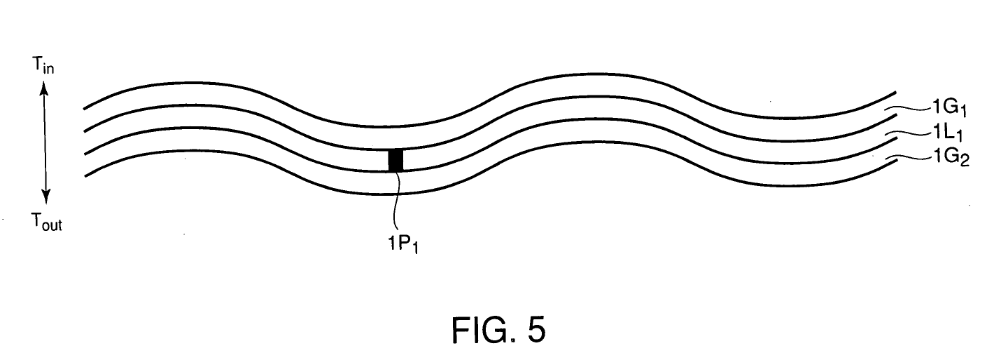

The surface of the substrate 1 opposite to the light-incident plane 1A is provided with “grooves” 1G (convex sections sticking out toward the light-incident plane 1A) and “lands” 1L (concave sections that cave in when viewed from the light-incident plane 1A). Each “groove” 1G and “land” 1L form a pair. A “groove” and a “land” may be spirally formed on the substrate 1. Or, several “groove”-“land” pairs may be concentrically formed on the substrate 1. The “grooves” 1G wobble on the substrate 1 at a fixed frequency, as illustrated in FIG. 5.

The organic-dye recording layer 2 and the semi-transparent reflective film 3 are formed in order on the substrate 1 to constitute the first layer structure L0.

An organic dye used for the recording layer 2 is cyanine, phthalocyanine, azoic dye, etc. The organic dye is applied over the substrate 1 by spin coating with ingredient adjustments and optimization of differential thermal characteristics, wavelength characteristics, etc.

The first layer structure L0 is basically identical to a single-layer optical storage medium, except for the reflective film 3 which is semi-transparent so that a laser beam can pass therethrough to a second layer structure L1 in recording or reproduction.

A substrate 4 also has “grooves” 4G that wobble on a surface of the substrate at a fixed frequency, opposite to the other surface 4B for labeling. A reflective film 5, an organic-dye recording layer 6 and a protective layer 7 are formed in order on the substrate 4 having the “grooves” 4G, thus constituting the second layer structure L1.

The substrate 4 is usually formed by resin injection molding like the counterpart 1 of the first layer structure L1 for higher productivity, although it does not require transparency to a laser beam in recording or reproduction.

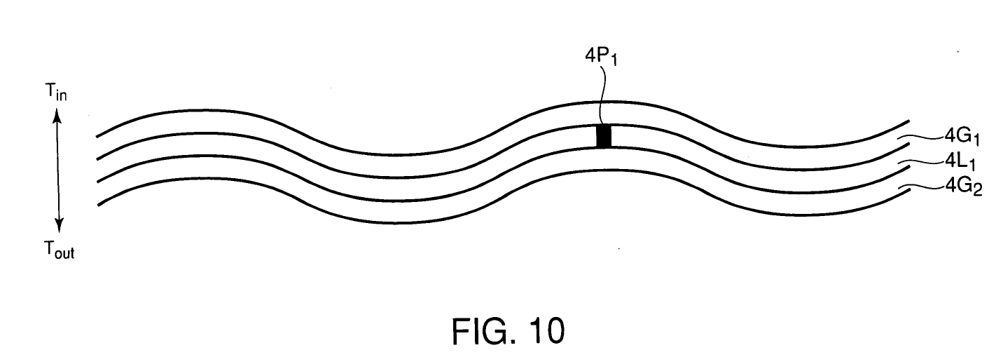

The substrate 4 is provided with the “grooves” 4G and “lands” 4L. The “grooves” 4G wobble on the substrate 4 at a fixed frequency, as illustrated in FIG. 10. The sections of the organic-dye recording layer 6 that correspond to the “grooves” 4G are data-recording tracks.

The semi-transparent reflective film 3 of the first layer structure L0 and the protective layer 7 of the second layer structure L1 are bonded to each other via an in-between (bonding) layer 10 so that the organic-dye recording layers 2 and 6 of the structures L0 and L1, respectively, face each other as the substrates 1 and 4 of the structures L0 and L1, respectively, are provided outermost, thus constituting the optical storage medium D2 according to the present invention.

In the optical storage medium D2, shown in FIG. 2, the concave sections of the substrate 4, that cave in when viewed from the light-incident plane 1A of the substrate 1 are the “grooves” 4G whereas the convex sections of the substrate 4, that stick out toward the light-incident plane 1A are the “lands” 4L.

In recording to the first layer structure L0, a laser beam is incident on the light-incident plane 1A of the substrate 1 and then focused on a dye film R0 of the organic-dye recording layer 2 formed on the “grooves” 1G.

In recording to the second layer structure L1, a laser beam is incident on the light-incident plane 1A of the substrate 1 and then focused on a dye film R1 of the organic-dye recording layer 6 formed on the “grooves” 4G.

The in-between layer 10 requires about 50 μm in thickness in order for the laser beams to be accurately focused on the organic-dye recording layers 2 and 6, respectively.

As disclosed above, this embodiment employs on-groove recording to the first layer structure L0 whereas in-groove recording to the second-layer structure L1.

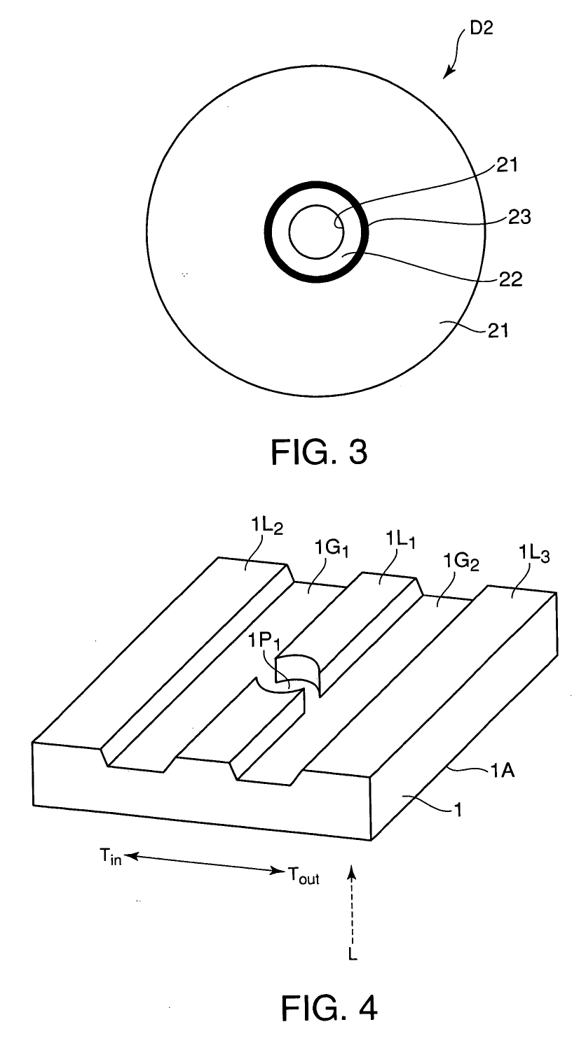

FIG. 3 is a plan view illustrating the optical storage medium D2. The optical storage medium D2 has a center hole 21 and a clamp area 22 therearound. Provided concentrically around the clamp area 22 is a data area (lead-in area) 23 provided around which is a recording area 24 that stores actual data such as video data and audio data.

Recorded in the lead-in area 23, as identification data (control data), are recording requirements for the optical storage medium D2 for achieving excellent recording/reproducing characteristics. The identification data indicates whether in-groove or on-groove recording to be performed to the recording area 24, a threshold level to be used in detection of pre-pit signals when pre-pits are reproduced by a recording/reproduction apparatus, etc.

The lead-in area 23 may be in a condition like ROM (Read Only Memory) or RAM (Random Access Memory). Alternatively, a high-frequency wobble or bits can be formed in a laser guide groove for gaining a tracking signal, as read-only recorded identification data. The lead-in area 23 may be provided in either the first layer structure L0 or the second layer structure L1.

FIG. 4 is an enlarged perspective view illustrating a fragment of the substrate 1 of the first layer structure L0.

Illustrated are “lands” 1L₁, 1L₂ and 1L₃, and “grooves” 1G₁ and 1G₂. Formed in the “land” 1L₁ is a pit called pre-pit (land pre-pit=LPP) 1P₁. The “land” 1L₂ is formed as closer to an inner-edge side Tᵢₙ whereas the “land” 1L₃ is formed as closer to an outer-edge side Tₒᵤₜ.

These “lands” and “grooves” are given reference signs 1L and 1G, respectively, in the following disclosure, whenever a particular “land” or “groove” is not referred to. Likewise, pre-pits are given reference signs 1P, thus, the pre-pit 1P₁ is one of pre-pits 1P.

Each of the “lands” 1L and “grooves” 1G is depicted with a straight line for simple illustration.

In FIG. 4, the land pre-pit 1P₁ is formed in such a way that the “grooves” 1G₁ and 1G₂ both next to the “land” 1L₁ are connected and a portion of the “land” 1L₁ is cut in so that the bottom of the land pre-pit 1P₁ is in the same plane with the bottoms of the “grooves” 1G₁ and 1G₂. Any other technique can be applied to form a land pre-pit if a laser beam can be modulated sufficiently.

Although only one land pre-pit 1P₁ is shown in FIG. 4 for simple illustration, a plurality of land pre-pits 1P are formed in each “land” 1L in accordance with given (DVD) standards.

FIG. 5 is an enlarged schematic illustration of “lands” 1L and “grooves” 1G in the first layer structure L0 of the optical storage medium D2 when viewed from the upper surface 4B for labeling in FIG. 2. The “groove” 1G₁ is depicted as closer to the inner-edge side Tᵢₙ whereas the “groove” 1G₂ is depicted as closer to the outer-edge side Tₒᵤₜ.

The sections of the organic-dye recording layer 2 that correspond to the “grooves” 1G (for example, 1G₁ and 1G₂) that stick out toward the light-incident plane 1A are data-recording tracks. This is because on-groove recording is performed to the first layer structure L0. The “grooves” 1G are wobbling as illustrated in FIG. 5.

Although only one land pre-pit 1P₁ is shown in FIG. 5, a plurality of land pre-pits 1P are provided in each “land” 1L (such as the “land” 1L₁) in accordance with the wobbling of the “grooves” 1G.

A land pre-pit (LPP) signal reproduced from each land pre-pit 1P is used for identifying address (location) information in the recording area 24 (FIG. 3).

In on-groove recording, the standard recording technique for DVD-R and DVD-RW, such as shown in FIGS. 4 and 5, for example, the land pre-pit 1P₁ is provided in the “land” 1L₁ closer to the outer-edge side Tₒᵤₜ and at a position corresponding to a position selected among several positions on the “groove” 1G₁ that are deviated most towards the outer-edge side Tₒᵤₜ due to wobbling. In other words, the land pre-pit 1P₁ carries an address on a data-recording track provided closer to the inner-edge side Tᵢₙ (a section of the recording layer 2 corresponding to the “groove” 1G₁).

Therefore, in recording or reproduction, an address of a position on the data-recording track corresponding to the “groove” 1G₁ where a laser beam hits can be identified by detecting a signal generated from the land pre-pit IP₁ closer to the outer-edge side Tₒᵤₜ than the “groove” 1G₁ is. In this case, the laser beam must hit the “groove” 1G₁ so that the center of the beam spot is positioned on almost a center line of the “groove” 1G₁ in a width direction between the inner-edge and outer-edge sides Tᵢₙ and Tₒᵤₜ.

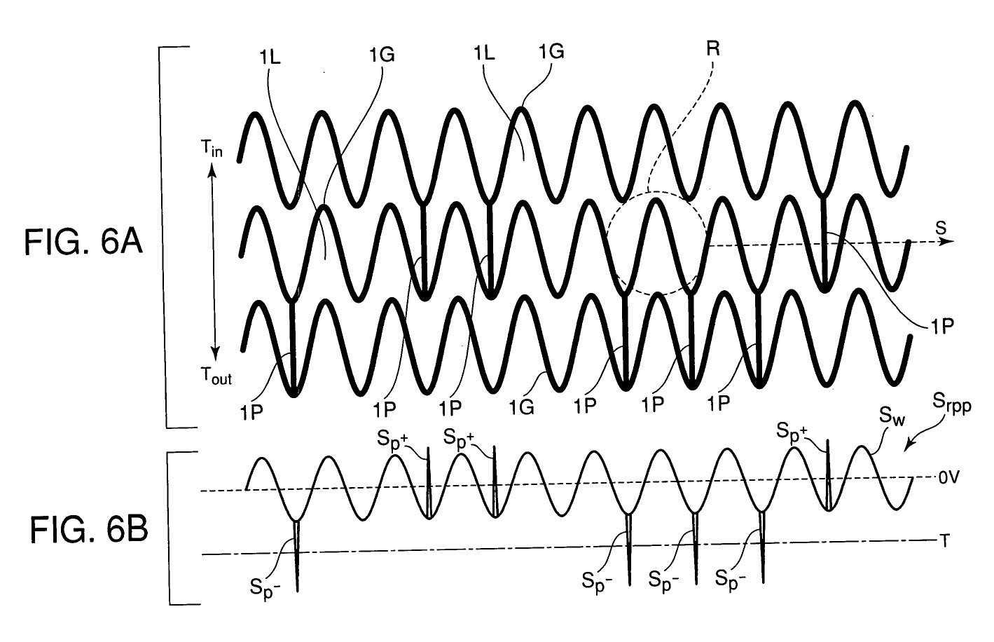

Illustrated in FIG. 6A are arrangements of the “grooves” 1G, the “lands” 1L and also the land pre-pits 1P. Also indicated in FIG. 6A is tracking control by using a return beam (reflected beam) R of a beam spot of a laser beam emitted by the optical head 34 (FIG. 11) mounted on a recording/reproduction apparatus of this invention while the optical head 34 is moving in a direction S. The beam spot goes straight in the direction S without affected by wobbling (although it actually moves in circle on the optical storage medium D2).

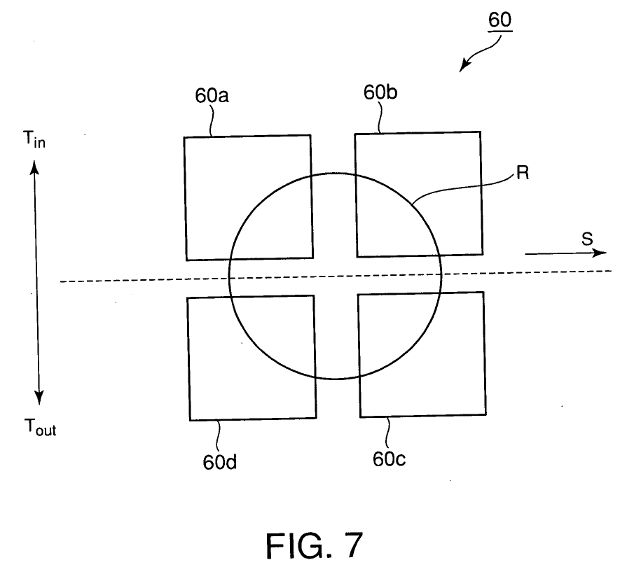

The optical head 34 is usually equipped with a quadrant photo-detector 60 shown in FIG. 7. Photo-detector elements 60a to 60d detect a return beam R reflected on the optical storage medium D2 while a beam spot of a laser beam emitted along the “grooves” 1G of the medium D2 is moving in the direction S while the medium D2 is rotating. In this case, the laser beam is a recording laser beam carrying a specific pulse pattern or a reproduction laser beam having a fixed power.

The quadrant photo-detector 60 generates a radial push-pull signal Sᵣₚₚ as expressed by the following expression (1):
Sᵣₚₚ=(Ia+Ib)−(Ic+Id) (1)
where (Ia+Ib) is an addition of outputs from the photo-detector elements 60a and 60b located closer to the inner-edge side Tᵢₙ, and (Ic+Id) is an addition of outputs from the photo-detector elements 60c and 60d located closer to the outer-edge side Tₒᵤₜ.

The radial push-pull signal Sᵣₚₚ is a wobble signal because intensity of the return beam R varies as the “grooves” 1G are wobbling between the inner- and outer-edge sides Tᵢₙ and Tₒᵤₜ in the direction S. In detail, the radial push-pull signal Sᵣₚₚ is a pre-pit-superposed wobble signal in which the wobble signal is superposed with pre-pit signals generated from the land pre-pits 1P.

The optical head 34 performs tracking while the position of a laser beam is controlled so that the absolute value of the radial push-pull signal Sᵣₚₚ becomes the smallest. In this case, the optical head 34 or its beam spot does not wobble or does not follow the wobbling “grooves” 1G. This is because the frequency at which the “grooves” 1G are wobbling is set higher or over an optical-head tracking servo control range for an actuator controller 35 (FIG. 11). Thus, a wobble signal appears on the radial push-pull signal Sᵣₚₚ, as discussed above.

Therefore, as schematically illustrated in FIG. 6B, the radial push-pull signal Sᵣₚₚ has a wobbling waveform (wobble signal) S_{w} with superposed land pre-pit signals Sₚ₋ and Sₚ₊.

The radial push-pull signal Sᵣₚₚ has polarities of positive in which the signal output becomes larger and negative in which the signal output becomes smaller from 0 volts. The land pre-pit signals Sₚ₋ and Sₚ₊ appear at the negative and positive sides, respectively, of the wobbling waveform S_{w}. This is because each land pre-pit 1P is provided as if it connects two adjacent “grooves” 1G, as illustrated in FIG. 4, and also a spot diameter of a recording/reproducing laser beam is larger than a width of each “groove” 1G.

Based on the expression (1), in FIGS. 6A and 6B, the land pre-pit signals Sₚ₋ appearing at the negative side are generated from the land pre-pits 1P located closer to the outer-edge side Tₒᵤₜ whereas the land pre-pit signals Sₚ₊ appearing at the positive side are generated from the land pre-pits 1P located closer to the inner-edge side Tᵢₙ. Therefore, in on-groove recording, the land pre-pit signals Sₚ₋ are regular or correct signals that indicate addresses whereas the signals Sₚ₊ are not.

As explained above, the land pre-pit signals required under on-groove recording are the land pre-pit signals Sₚ₋ appearing at the negative side in amplitude of the radial push-pull signal Sᵣₚₚ. Thus, as already known, a threshold level T such as shown in FIG. 6B is set in a recording/reproduction apparatus, and used for detecting land pre-pit signals Sₚ₋ that appear at the negative side in amplitude of the radial push-pull signal Sᵣₚₚ. The signal components that have levels higher than the threshold level T at the negative (first) side in amplitude of the radial push-pull signal Sᵣₚₚ are detected as land pre-pit signals Sₚ₋ required under on-groove recording.

The land pre-pits 1P are arranged so that they do not align in the radius direction on the substrate 1, which prevents land pre-pit signals Sₚ₋ and Sₚ₊ from simultaneously appearing at the negative and positive sides, respectively, of the radial push-pull signal Sᵣₚₚ, thus avoiding erroneous detection of land pre-pit signals.

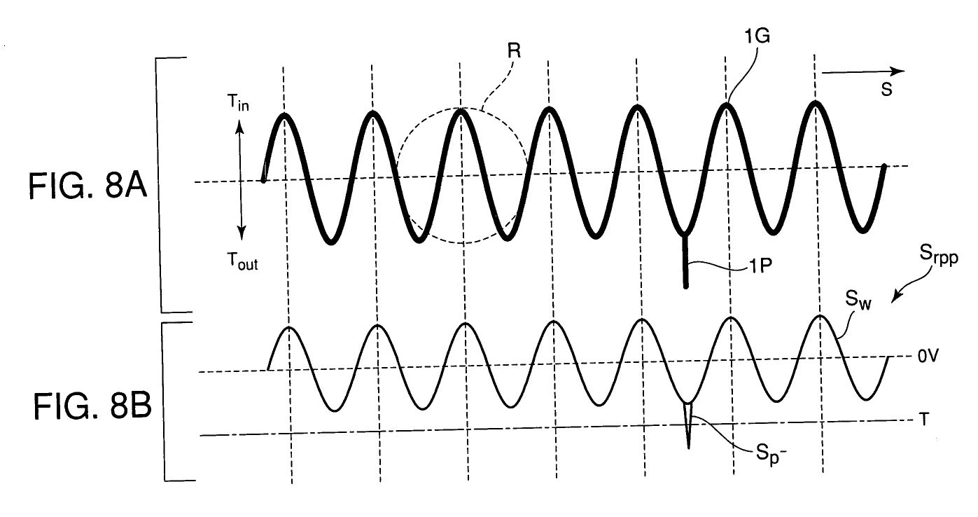

Illustrated in FIG. 8A are “grooves” 1G and a land pre-pit 1P formed between adjacent two “grooves” 1G in the layer structure L0 in on-groove recording. This figure corresponds to a portion of FIG. 6A. Illustrated in FIG. 8B is a radial push-pull signal Sᵣₚₚ generated based on the expression (1) using a return beam R detected when a laser beam is emitted to the “grooves” 1G.

In this embodiment, the “grooves” 1G and “lands” 1L are formed as convex and concave sections, respectively, when viewed from the light-incident plane 1A. Thus, the amount the return beam R from the “grooves” 1G is larger than that from the “lands” 1L. For example, in FIG. 8A, the amount of the return beam R is larger as closer to the inner-edge side Tᵢₙ than the outer-edge side Tₒᵤₜ with respect to the direction S. Therefore, a radial push-pull signal Sᵣₚₚ generated based on the expression (1) carries larger positive signal portions when the “grooves” 1G are wobbling at the inner-edge side Tᵢₙ whereas larger negative signal portions when the “grooves” 1G are wobbling at the outer-edge side Tₒᵤₜ.

The second layer structure L1 is disclosed next.

The embodiment employs in-groove recording to the second layer structure L1. Data is recorded to the sections (data-recording tracks) of the recording layer 6 that correspond to the “grooves” 4G that cave in when viewed from the light-incident plane 1A, as shown in FIG. 2.

Land pre-pits 4P are formed in the “lands” 4L that stick out toward the light-incident plane 1A. The bottom of each land pre-pit 4P lies in almost the same plane as the bottoms of adjacent two “grooves” 4G that sandwich the land pre-pit 4P. Each land pre-pit 4P has almost the same configuration as the counterpart 1P shown in FIG. 4.

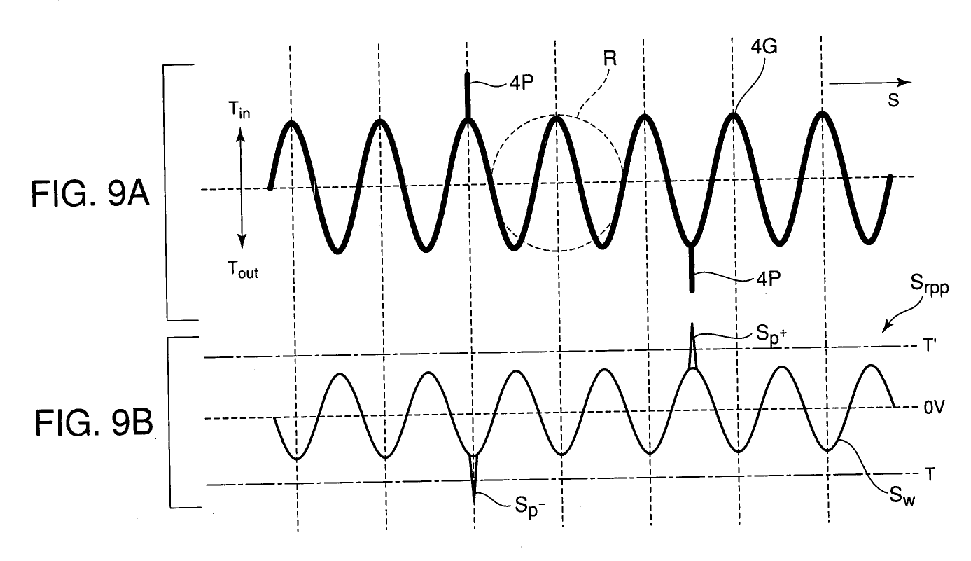

Illustrated in FIG. 9A are “grooves” 4G and the land pre-pits 4P each formed between adjacent two “grooves” 4G in the layer structure L1 in in-groove recording. Illustrated in FIG. 9B is a radial push-pull signal Sᵣₚₚ generated based on the expression (1) using a return beam R detected when a laser beam is emitted to the “grooves” 4G.

In this embodiment, the “grooves” 4G and “lands” 4L are formed as concave and convex sections, respectively, when viewed from the light-incident plane 1A. Thus, the amount the return beam R from the “grooves” 4G is relatively smaller than that from the “lands” 4L. In FIG. 9A, the amount of the return beam R is larger as closer to the outer-edge side Tₒᵤₜ than the inner-edge side Tᵢₙ with respect to the direction S. Therefore, a radial push-pull signal Sᵣₚₚ generated based on the expression (1) carries larger negative signal portions when the “grooves” 4G are wobbling at the inner-edge side Tᵢₙ whereas larger positive signal portions when the “grooves” 4G are wobbling at the outer-edge side Tₒᵤₜ.

However, in-groove recording suffers a problem discussed below when the land pre-pits 4P are provided in the “lands” 4L as closer to the outer-edge side Tₒᵤₜ where the “grooves” 4G are wobbling most, like the land pre-pits 1P in on-groove recording.

In detail, the land pre-pits 4P are provided as concave sections in the layer structure L1, which causes less amount of a return beam R, and hence, land pre-pit signals Sₚ₊ appear at the positive side, as shown in FIG. 9B. Such land pre-pit signals Sₚ₊ cannot be detected if the known technique is employed for the layer structure L1 in which a threshold level T is set at the negative side in amplitude of a wobble signal S_{w}.

[First Modification]

To solve such a problem, land pre-pits 4P are provided in the second layer structure L1 as disclosed below as a first modification to the embodiment of the optical storage medium D2 according to the present invention.

FIG. 10 is an enlarged schematic illustration of “lands” 4L and “grooves” 4G in the second layer structure L1 of the optical storage medium D2 when viewed from the upper surface 4B for labeling in FIG. 2. Although only one land pre-pit 4P₁ is shown in FIG. 10, a plurality of land pre-pits 4P₁ are provided in the “land” 4L₁ closer to the inner-edge side Tᵢₙ and at positions corresponding to positions selected among several positions on “groove” 4G₂ that are deviated most towards the inner-edge side Tᵢₙ due to wobbling. Each pre-pit 4P₁ carries an address on a data-recording track provided closer to the outer-edge side Tₒᵤₜ (a section of the recording layer 6 corresponding to the “groove” 4G₂).

Such provision of land pre-pits 4P allows land pre-pit signals Sₚ₋ to appear at the negative side in amplitude of the wobbling waveform S_{w}, as shown in FIG. 9B. The land pre-pit signals Sₚ₋ can be detected with the threshold level T, in the same way as discussed above.

Moreover, in the first modification, recorded in the lead-in area 23 (FIG. 3) is identification data that indicates on-groove recording to the first layer structure L0 whereas in-groove recording to the second layer structure L1. The recording/reproduction apparatus (FIG. 11) of this invention reads the identification data and performs on-groove and in-groove recording to the first and second layer structures L0 and L1, respectively. The identification data may further carry a threshold level T to be set for detecting land pre-pit signals.

Therefore, the first modification provides a dual-layer optical storage medium that achieves high recording/reproduction quality in both layer structures L0 and L1 with a simple and economical method as disclosed above.

Moreover, the first modification allows use of the threshold level T for precise detection of land pre-pit signals from the second layer structure L1 under in-groove recording, in addition to the first layer structure L0 under on-groove recording.

[Second Modification]

As discussed above, land pre-pits 4P give land pre-pit signals Sₚ₊ as shown in FIG. 9B in in-groove recording when the pre-pits 4P are provided in the same way as on-groove recording.

To cope with such appearance of land pre-pit signals Sₚ₊, in a second modification to the embodiment of the optical storage medium D2 according to the present invention, a threshold level T′ is set at the positive (second) side in amplitude of the wobbling waveform S_{w} to detect land pre-pit signals Sₚ₊, under in-groove recording, from land pre-pits 4P provided in the same way as on-groove recording.

The threshold level T′ is set higher enough than the positive peak of the wobbling waveform Sw but lower than the peak of each land pre-pit signal Sₚ₊.

Moreover, in the second modification, identification data recorded in the lead-in area 23 (FIG. 3) indicates on-groove recording to the first layer structure L0 whereas in-groove recording to the second layer structure L1, like the first modification. The identification data in the second modification further carries the threshold level T for detecting land pre-pit signals from the first layer structure L0 and the threshold level T′ for detecting land pre-pit signals from the second layer structure L1. The recording/reproduction apparatus (FIG. 11) of this invention reads the threshold levels T and T′ and sets them at the negative (first) and positive (second) sides, respectively, in amplitude of the wobble signal S_{w} for detecting land pre-pit signals from the first and second layer structures L0 and L1, respectively.

[Recording/Reproduction Apparatus]

FIG. 11 shows a block diagram of an embodiment of a recording/reproduction apparatus for recording/reproduction to/from the optical storage medium D2 according to the present invention.

The present invention is also applicable to a recording-only apparatus and a reproduction-only apparatus. In other words, in the present invention, the recording/reproduction apparatus is defined as an apparatus that performs at least either recording or reproduction.

The optical storage medium D2 is rotated by a spindle motor 31 when it is set on the tray 58. The spindle motor 31 is controlled by a rotation controller 32 so that its rotating speed reaches a recording linear velocity corresponding to a target recording speed. Provided as movable in the radius direction of the optical storage medium D2 is an optical head 34 equipped with a semiconductor laser (LD) 33 for use in recording, reproduction or erasing to the optical storage medium D2, an objective lens (not shown) for focusing an emitted laser beam of the LD 33, and the quadrant photoreceptor (PD) 60 shown in FIG. 7.

A recommendable light source for recording in the optical recording apparatus of this embodiment is a high-intensity light source of a laser beam or strobe light, for example. Most recommendable is a semiconductor laser for compactness, low power consumption and easiness in modulation.

The quadrant photo-detector 60 of the optical head 34 receives a reflected light beam of a laser beam emitted to the optical storage medium D2 from the LD 33. Based on the light beam received by the quadrant photo-detector 60, a signal generator 57 generates a radial push-pull signal Sᵣₚₚ and outputs it to a wobble• LPP (Land Pre-Pit) detector 36. Moreover, based on the light beam received by the quadrant photo-detector 60, the signal generator 57 outputs a focus error signal and a tracking error signal to a drive controller 54. Furthermore, the signal generator 57 generates a reproduced (RF) signal that is a composite signal and outputs it to a reproduced-signal processor 56.

The drive controller 54 controls an actuator controller 35 based on the focus and tracking error signals supplied by the signal generator 57. The actuator controller 35 controls the optical head 34 in focusing and tracking to the optical storage medium D2.

Moreover, the drive controller 54 controls the rotation controller 32, the wobble•LPP detector 36, an address demodulator 37, and a recording-clock generator 38. The drive controller 54 is controlled by a system controller 55.

The wobble•LPP detector 36, equipped with a programmable band-pass filter (BPF) 361 and a threshold-level setter 362, outputs detected wobble and LPP (Land Pre-Pit) signals to the address demodulator 37. The address demodulator 37 demodulates and outputs address data from the detected wobble and LPP signals.

Disclosed next in detail is a reproduction operation of the recording/reproduction apparatus from the optical storage medium D2.

When the optical storage medium D2 having data already recorded in the recording area 24 (FIG. 3) is set on the tray 58, the LD 33 of the optical head 34 emits a laser beam to the lead-in area 23 (FIG. 3). The optical head 34 supplies a reflected beam received by the quadrant photo-detector 60 to the signal generator 57. The signal generator 57 generates a reproduced signal based on the reflected beam and supplies it to the reproduced-signal processor 56. The reproduced-signal processor 56 demodulates the reproduced signal and supplies identification data (control data) to the system controller 55. As disclosed above, the identification data includes recording-mode data indicating in-groove or on-groove recording, a threshold-level data indicating the threshold level T or T′ for detection of LPP signals, etc.

The system controller 55 writes the identification data into a memory 551 and controls the drive controller 54 based on the identification data. The drive controller 54 controls the actuator controller 35, the wobble•LPP detector 36 and the address demodulator 37, under control by the system controller 55.

The actuator controller 35 is controlled by a control signal sent from the drive controller 54 which indicates a recording mode that is in-groove or on-groove recording to the layer structure L0 or L1. Under the control signal, the actuator controller 35 performs focusing and tracking control to the optical head 34 to match in-groove or on-groove recording performed to the layer structure L0 or L1.

The threshold-level setter 362 of the wobble•LPP detector 36 sets the threshold level T or T′ under a control signal, supplied from the system controller 55 via the drive controller 54, that indicates the threshold level T or T′ for detecting LPP signals.

The optical head 34 outputs an optical signal received from the recording area 24 (FIG. 3) to the signal generator 57. Based on the optical signal, the signal generator 57 generates a reproduced signal and outputs it to the reproduced-signal processor 56. The signal generator 57 further generates a radial push-pull signal Sᵣₚₚ and outputs it to the wobble•LPP detector 36. Based on the radial push-pull signal Sᵣₚₚ, the BPF 361 detects a wobble signal S_{w} and the threshold-level setter 362 detects an LPP signal Sₚ₊ or Sₚ₋ using the threshold level T or T′ set as above. The detected LPP signal Sₚ₊ or Sₚ₋ is output to the address demodulator 37.

The address demodulator 37 demodulates the LPP signal Sₚ₊ or Sₚ₋ to gain address data which is output to the drive controller 54.

The reproduced-signal processor 56 demodulates the reproduced signal obtained from the optical signal received from the recording area 24 and outputs a demodulated signal as reproduced information.

Disclosed next in detail is a recording operation of the recording/reproduction apparatus to the optical storage medium D2.

When the optical storage medium D2 having the recording area 24 (FIG. 3) with un-recorded sections is set on the tray 58, the optical head 34 emits a laser beam to the medium D2.

The drive controller 54 outputs a wobble signal Sw supplied from the wobble•LPP detector 36 to the recording-clock generator 38 and a demodulated address data supplied from the address demodulator 37 to the system controller 55.

The demodulated address data is also input to the recording-clock generator 38, equipped with a PLL synthesizer 381, that generates a recording channel clock and outputs it to a recording-pulse generator 39 and a pusle-number controller 50.

The system controller 55 controls an EFM+ encoder 52, a mark-length counter 51, the pulse-number controller 50, and an LD driver 53, in addition to the drive controller 54, as already explained.

The EFM+ encoder 52 modulates input information to be recorded into modulated data with 8-16 modulation and outputs it to the recording-pulse generator 39 and the mark-length counter 51. The mark-length counter 51 works as a mark-length generator that counts intervals of inversion of the modulated data to generate mark-length data, the counted value being output to the recording-pulse generator 39 and the pulse-number controller 50. The pulse-number controller 50 controls the recording-pulse generator 39 for specific recording pulses based on the supplied counted value and recording-channel clock.

The recording-pulse generator unit 39 generates a pulse control signal and outputs it to the LD driver 53. The LD driver 53 generates a recording pulse pattern based on the pulse control signal.

The generated recording pulse pattern is input to the optical head 34. The optical head 34 records information to be recorded on the optical storage medium D2 while controlling the LD 33 to output an LD emission waveform having a desired recording pulse pattern and power.

Also, in the recording operation, the actuator controller 35 is controlled by a control signal sent from the drive controller 54 which indicates a recording mode that is in-groove or on-groove recording to the layer structure L0 or L1. Under the control signal, the actuator controller 35 performs focusing and tracking control to the optical head 34 for in-groove or on-groove recording.

Moreover, the threshold-level setter 362 of the wobble•LPP detector 36 sets the threshold level T or T′ under a control signal supplied from the system controller 55 via the drive controller 54 that indicates the threshold level T or T′ for detecting LPP signals.

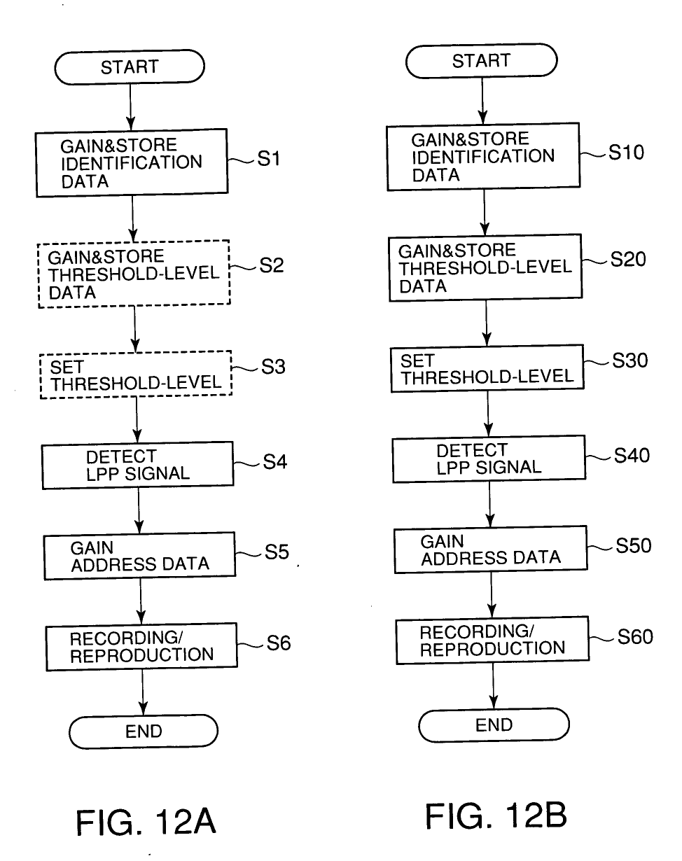

Shown in FIGS. 12A and 12B are flowcharts for the recording/reproduction apparatus in the recording/reproduction operation disclosed above.

Disclosed first with respect to FIG. 12A is the recording/reproduction operation of the recording/reproduction apparatus for the first modification to the embodiment of the optical storage medium D2 according to the present invention.

In step S1, the system controller 55 obtains identification data demodulated by the reproduced-signal processor 56 based on the reproduced signal from the lead-in area 23 (FIG. 3) and stores it in the memory 551. Recording-mode data included in the identification data indicates on-groove recording for the layer structure L0 and in-groove recording for the layer structure L1 (first modification). Based on the stored recording-mode data, the drive controller 54 controls the actuator controller 35 for on-groove or in-groove recording.

In step S2, the drive controller 54 obtains threshold-level data included in the stored identification data, which indicates the threshold level T to be set for both of the layer structures L0 and L1 for detection of negative LPP signals Sₚ₋ from land pre-pits 1P and 4P, as shown in FIGS. 8B and 9B.

Next, in step S3, the drive controller 54 sets the threshold level T in the threshold-level setter 362.

Since the threshold level T is used for both of the layer structures L0 and L1, the threshold level T can be previously set in the threshold-level setter 362 as fixed data. In this case, steps S2 and S3 can be omitted.

In step S4, the wobble•LPP detector 36 detects LPP signals Sₚ₋ superposed on a radial push-pull signal Sᵣₚₚ based on the threshold level T and outputs the detected signals to the address demodulator 37.

In step S5, the address demodulator 37 demodulates address data from the LPP signals Sₚ₋.

In step S6, the recording/reproduction operation is performed to the layer structure L0 or L1 based on the demodulated address data.

Disclosed next with respect to FIG. 12B is the recording/reproduction operation of the recording/reproduction apparatus for the second modification to the embodiment of the optical storage medium D2 according to the present invention.

The steps in FIG. 12B the same as FIG. 12A are not explained in detail.

In step S10, the system controller 55 obtains identification data and stores it in the memory 551.

In step S20, the drive controller 54 obtains threshold-level data included in the stored identification data, which indicates the threshold level T to be set for the layer structure L0 for detection of negative LPP signals Sₚ₋ from the land pre-pits 1P, and also the threshold level T′ to be set for the layer structure L1 for detection of positive LPP signals Sₚ₊ from the land pre-pits 4P.

The steps that follow step S20 for the layer structure L0 using the threshold level T are identical to those in FIG. 12A and hence their explanations are omitted.

Disclosed below are the steps for the layer structure L1 in recording/reproduction.

In step S30, the drive controller 54 sets the threshold level T′ in the threshold-level setter 362 based on the obtained threshold-level data.

In step S40, the wobble•LPP detector 36 detects LPP signals Sₚ₊ superposed on a radial push-pull signal Sᵣₚₚ based on the threshold level T′ and outputs the detected signals to the address demodulator 37.

In step S50, the address demodulator 37 demodulates address data from the LPP signals Sₚ₊.

In step S60, the recording/reproduction operation is performed to the layer structure L1 based on the demodulated address data.

As disclosed above, the present invention provides dual-layer optical storage media that can be manufactured by the simple and economical method. Particularly, in multilayer optical storage media having two or more of recording layers, the present invention allows selective recording between in-groove or on-groove recording for each recording layer, which enhances flexibility in manufacture, thus enabling economical provision of multilayer optical storage media.

The land pre-pits 1P and 4P disclosed above have the configuration shown in FIG. 4 in the embodiment. FIG. 4 illustrates that the “land” 1L₁ is completely interrupted by the land pre-pit 1P₁.

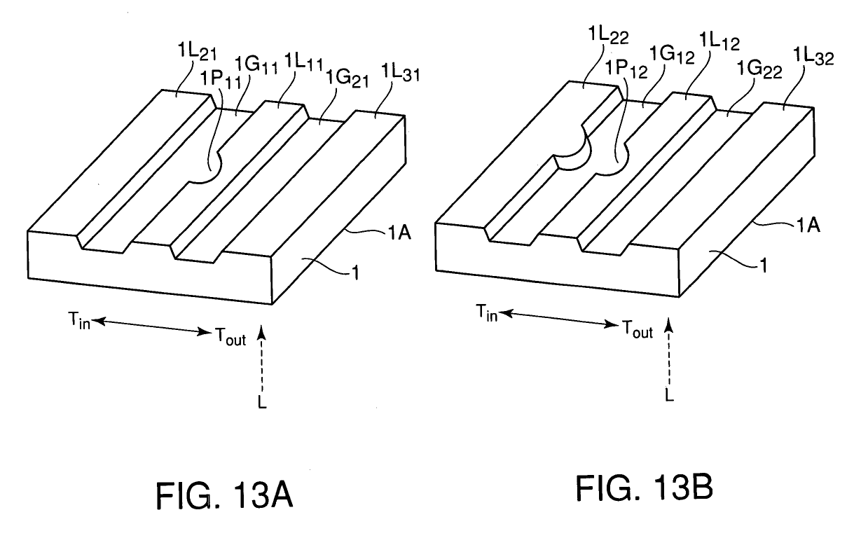

Not only that, land pre-pits 1P for the layer structure L0 may have a configuration such as a land pre-pit 1P₁₁ or a land pre-pit 1P₁₂ illustrated in FIG. 13A or 13B, respectively.

FIG. 13A illustrates that only a portion of a “land” 1L₁₁ is cut in so that the “land” 1L₁₁ is not completely interrupted by the land pre-pit 1P₁₁.

FIG. 13B illustrates that a portion of a “land” 1L₂₂ corresponding to a portion of a “land” 1L₁₂ that is cut in by the land pre-pit 1P₁₂ is projected so that a “groove” 1G ₁₂ located between the two “lands” has an almost constant width.

The modifications shown in FIGS. 13A and 13B are also applicable to land pre-pits 4P for the layer structure L1.

The land pre-pits 1P₁₁ and 1P₁₂ illustrated in FIGS. 13A and 13B, respectively, provide almost the same signal waveform as that shown in FIG. 6B. Likewise, when land pre-pits 4P are formed as illustrated in FIG. 13A or 13B, they provide almost the same signal waveform as that shown in FIG. 9B.

In the dual-layer optical storage media according to the present invention, all of the identification data (control data) concerning the layer structures L0 and L1 are recorded in the lead-in area 23 of the layer structure L0. Under this identification-data recording, the recording/reproduction apparatus adapted for both single- and dual-layer optical storage media can identify the type of optical storage media by reading the identification data stored in the layer structure L0 only.

Nonetheless, it is preferable to previously record the same identification data in the lead-in areas 23 of both of the layer structures L0 and L1. The same data includes the recording-mode data indicating in-groove or on-groove recording to the layer structures L0 and L1 and the threshold-level data indicating the threshold levels T and/or T′ for detection of LPP signals, etc.

This recording of the same identification data to both of the layer structures L0 and L1, which does not necessary to record different identification data to the lead-in areas 23 of the structures L0 and L1, simplifies manufacturing processes, thus achieving further economical manufacture of optical storage media.

In case of manufacturing multilayer optical storage media having three or more of recording layers, recording of the same identification data to multilayers allows either in- or on-groove recording mode to be applied to each recording layer, or different recording modes to be applied to a plurality of recording layers, with no consideration of compatibility with the recording/reproduction apparatus.

As disclosed above in detail, the present invention achieves economical manufacture of optical storage media having a plurality of recording layers, with excellent recordability and reproducibility for each recording layer.

Moreover, the present invention achieves precise detection of pre-pit signals even under in-groove recording, thus offering excellent recordability and reproducibility.

What is claimed is:

1. An optical storage medium comprising:
a first layer structure including a first substrate having a light-incident surface via which light is incident for recording or reproduction and a first surface having first concave sections and first convex sections, formed in order on the first surface being at least a first recording layer and a semi-transparent film, the first convex sections sticking out toward the light-incident surface, first recording tracks being provided on first portions of the first recording layer, the first portions corresponding to the first convex sections that are wobbling at a fixed frequency between an inner edge and an outer edge of the optical storage medium; and
a second layer structure including a second substrate having a second surface having second concave sections and second convex sections, formed in order on the second surface being at least a reflective film and a second recording layer, the second concave sections caving in when viewed from the light-incident surface, the second layer structure being bonded to the first layer structure so that the first surface of the first substrate and the second surface of the second substrate face each other, second recording tracks being provided on second portions of the second recording layer, the second portions corresponding to the second concave sections that are wobbling at a fixed frequency between the inner and outer edges, at least one second convex section being provided with a pre-pit carrying address data for one of second recording tracks closer to the outer edge than the pre-pit is, the second convex section provided with the pre-pit being located closer to the inner edge than the second concave sections are, the location being corresponding to one of several second concave sections that are wobbling most towards the inner edge.

2. The optical storage medium according to claim 1 having pre-recorded control data for recording to the second recording tracks.

3. The optical storage medium according to claim 2, wherein the control data is pre-recorded in the first and second layer structures.

4. An optical storage medium comprising:
a first layer structure including a first substrate having a light-incident surface via which light is incident for recording or reproduction and a first surface having first concave sections and first convex sections, formed in order on the first surface being at least a first recording layer and a semi-transparent film, the first convex sections sticking out toward the light-incident surface, first recording tracks being provided on first portions of the first recording layer, the first portions corresponding to the first convex sections that are wobbling at a fixed frequency between an inner edge and an outer edge of the optical storage medium; and
a second layer structure including a second substrate having a second surface having second concave sections and second convex sections, formed in order on the second surface being at least a reflective film and a second recording layer, the second concave sections caving in when viewed from the light-incident surface, the second layer structure being bonded to the first layer structure so that the first surface of the first substrate and the second surface of the second substrate face each other, second recording tracks being provided on second portions of the second recording layer, the second portions corresponding to the second concave sections that are wobbling at a fixed frequency between the inner and outer edges, at least one second convex section being provided with a pre-pit, the second convex section provided with the pre-pit being located closer to the outer edge than the second concave sections are, the location being corresponding to one of several second concave sections that are wobbling most towards the outer edge,
wherein the optical storage medium has pre-recorded control data for recording to the second recording tracks, the control data further indicating a threshold level, to be used for detecting a pre-pit signal that is generated when the pre-pit is reproduced, to be set at a first side or a second side opposite to the first side in amplitude of a wobble signal that corresponds to the wobbling second concave sections.

5. The optical storage medium according to claim 4, wherein the control data is pre-recorded in the first and second layer structures.

6. An apparatus for performing at least either recording or reproduction comprising:
an optical head for emitting a light beam for recording or reproduction to and receiving a return beam from an optical storage medium having recording tracks that wobble at a fixed frequency, provided between the recording tracks being pre-pits that carry address data for the recording tracks, and having pre-stored control data indicating a threshold level to be used for detecting pre-pit signals that are generated when the pre-pits are reproduced;
a processor to gain and process the control data from the return beam;
a generator to generate a pre-pit-superposed wobble signal based on the return signal, the pre-pit-superposed wobble signal having a wobble signal that corresponds to the wobbling recording tracks and pre-pit signals that correspond to the pre-pits, the pre-pit signals being superposed on the wobble signal;
a detector to detect the pre-pit signals from the pre-pit-superposed wobble signal by using the threshold level gained from the processed control data;
a demodulator to demodulate the detected pre-pit signals to gain the address data; and
a controller to control the detector based on the processed control data so that the gained threshold level is set at a first side or a second side opposite to the first side in amplitude of the pre-pit-superposed wobble signal.

7. A method of performing at least either recording or reproduction comprising the steps of:
emitting a light beam for recording or reproduction to and receiving a return beam from an optical storage medium having recording tracks that wobble at a fixed frequency, provided between the recording tracks being pre-pits that carry address data for the recording tracks, and having pre-stored control data indicating a threshold level to be used for detecting pre-pit signals that are generated when the pre-pits are reproduced;
processing the control data gained from the return beam;
generating a pre-pit-superposed wobble signal based on the return signal, the pre-pit-superposed wobble signal having a wobble signal that corresponds to the wobbling recording tracks and pre-pit signals that correspond to the pre-pits, the pre-pit signals being superposed on the wobble signal;
detecting the pre-pit signals from the pre-pit-superposed wobble signal by using the threshold level gained from the processed control data;
demodulating the detected pre-pit signals to gain the address data; and
controlling the detector based on the processed control data so that the gained threshold level is set at a first side or a second side opposite to the first side in amplitude of the pre-pit-superposed wobble signal.
